(19) United States
(12) Patent Application Publication
(10) Pub. No.: US 2011/0063205 A1
(43) Pub. Date: Mar. 17, 2011

(54) DISPLAY MAGNIFIER

(75) Inventor: Stefan Kufner, Kueps (DE)

(73) Assignee: MOTOROLA, INC., Schaumburg, IL (US)

(21) Appl. No.: 12/559,886

(22) Filed: Sep. 15, 2009

(51) Int. Cl. G09G 5/00; G02B 5/18

(52) U.S. Cl. 345/156; 359/566; 455/566; 345/55

(57) ABSTRACT

Disclosed is a display element that includes a display screen and a transparent cover overlying the display screen. The output from the display screen is magnified to occupy at least some of the transparent cover. The display element includes an arrangement of diffractive and refractive elements disposed between the display screen and the transparent cover that provide significant magnification without adding significant thickness to the display element. In some embodiments, the diffractive and refractive elements are embodied in a number of optical microelements, in some cases at least one optical microelement per pixel of the display screen. Some embodiments include microlenses that collimate the light emitted by the display screen. The display element can be “anamorphotic,” that is, the magnification in one direction differs from that in another. Some embodiments provide at least two levels of magnification. Liquid matching switches can be used to control the level of magnification.

### FIELD OF THE INVENTION

The present invention is related generally to electronic hardware and, more particularly, to computer displays.

### BACKGROUND OF THE INVENTION

Portable personal electronics devices (e.g., cell phones, personal digital assistants, portable computers) are running increasingly complex applications. These applications often need to display increasingly complex information to their users. Larger display screens can, of course, present complex information more clearly than can small screens.

However, larger display screens cost more than smaller ones, use more power, and take up more volume in the portable device. Thus, the simple solution of providing larger display screens conflicts with the desire to make these portable devices both smaller and cheaper.

Many portable devices include, as part of their housing, a transparent cover that overlies and protects the display screen itself. This transparent cover often extends beyond the edges of the display screen. Attempts have been made to magnify the size of the display produced by the display screen until the display occupies some of the larger area provided by the transparent cover. However, these attempts have only been able to provide a useful amount of magnification when there is a significant distance between the surface of the display screen and the inner surface of the transparent cover. Providing that distance runs counter to another important desire among users, that is, the desire for these devices to be ever thinner as well as smaller.

### BRIEF SUMMARY

The above considerations, and others, are addressed by the present invention, which can be understood by referring to the specification, drawings, and claims. According to aspects of the present invention, a display element includes a display screen and a transparent cover overlying the display screen. The output from the display screen is magnified to occupy at least some of the transparent cover. The display element includes an arrangement of diffractive and refractive elements disposed between the display screen and the transparent cover that provide significant magnification without adding significant thickness to the display element. The display element can be used in personal electronic devices such as cellular telephones, personal digital assistants, and personal computers.

In some embodiments, the diffractive and refractive elements are embodied in a number of optical microelements, in some cases at least one optical microelement per pixel of the display screen. These optical microelements can be formed by known microlithographic techniques.

Some embodiments include microlenses among the optical microelements. Each microlens collimates the light emitted by one pixel of the display screen.

In some embodiments, the degree of magnification produced by the display element is the same in all directions. In other embodiments, the display element is built to be “anamorphotic,” that is, the magnification in one direction differs from that in another.

Some embodiments provide at least two levels of magnification (e.g., one level of no magnification and one level of positive magnification). Liquid matching switches can be used to control the level of magnification. Switching between magnification levels can be put under the direct control of a user. In some cases, software running on the user's electronic device (e.g., an operating system utility or a user application) can set the level of magnification as appropriate for the information currently being displayed.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIGS. 1a and 1b are schematics of a personal electronics device in which the present invention may be embodied;

FIGS. 2a and 2b are cross-sections of a display element showing a normal (non-magnified) display and a magnified display;

FIG. 3 is a cross-section of a magnifying display element that uses diffractive and refractive elements according to an embodiment of the present invention;

FIG. 4 is a cross-section of a magnifying display element with collimating microlenses; and

FIG. 5 is a cross-section of a magnifying display element that includes liquid matching switches in order to switch among states of magnification (or among one state of non-magnification and one or more states of varying levels of magnification).

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

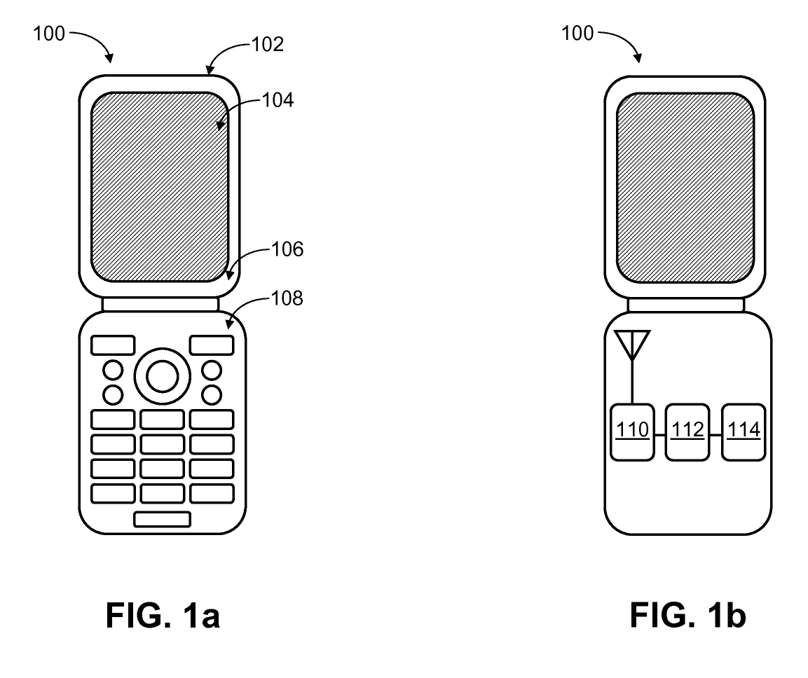

FIGS. 1a and 1b show a personal electronics device 100 (e.g., a cellular telephone, personal digital assistant, or personal computer) that incorporates an embodiment of the present invention. FIGS. 1a and 1b show the device 100 as a cellular telephone with its cover open. When open, the cover presents a display element 102 to a user of the device 100. The display element 102 includes a main display screen 104 and a substantially transparent cover 106 that overlays and protects the main display screen 104. Importantly for the present invention, the transparent cover 106 extends beyond the edges of the main display screen 104.

Typically, the main display screen 104 is used for most high-fidelity interactions with the user of the personal electronics device 100. For example, the main display screen 104 is used to show video or still images, is part of a user interface for changing configuration settings, and is used for viewing call logs and contact lists. To support these interactions, the main display screen 104 is of high resolution and is as large as can be comfortably accommodated in the device 100. In some embodiments, the device 100 may have a second and possibly a third display screen for presenting status messages. These screens are generally smaller than the main display screen 104. They can be safely ignored for the remainder of the present discussion.

The typical user interface of the personal electronics device 100 includes, in addition to the main display screen 104, a keypad 108 or other user-input devices. (If the main display screen 104 is a touch screen, then it is both an output device and a user-input device.)

FIG. 1b illustrates some of the more important internal components of the personal electronics device 100. Most devices 100 include a communications transceiver 110, a processor 112, and a memory 114. Other necessary or useful components (e.g., a battery or other power supply) are well known in the art but are not important to the present discussion and are therefore not depicted in the figures.

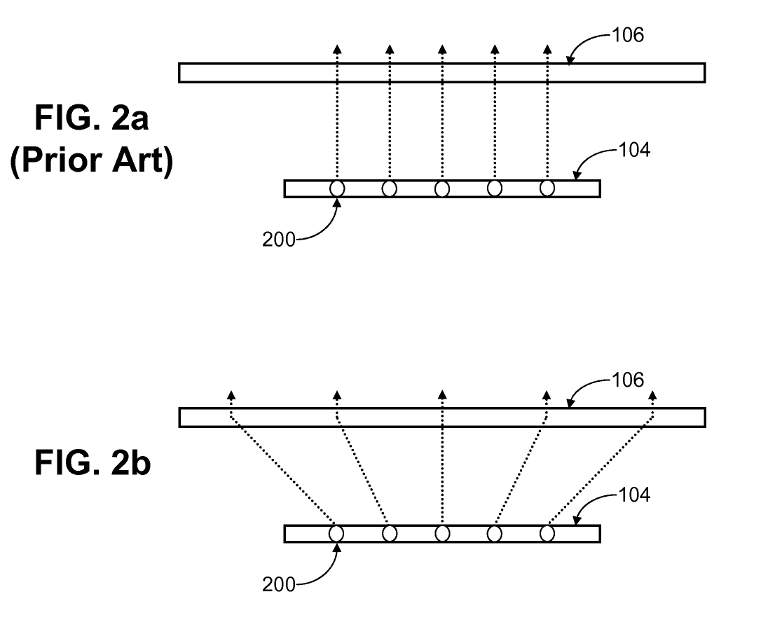

FIG. 2a is a simplified cross-sectional view of a display screen 104 and its overlaying transparent cover 106 as known in the prior art. The display screen 104 includes light-emitting pixels 200. (For purposes of clarity, FIG. 2a only shows a one-dimensional array of five pixels 200. As is well known, actual display screens 104 can have two-dimensional arrays of pixels 200 with each dimension measuring several hundred pixels in extent.) The light emitted from each pixel 200 in the display screen 104 goes directly “up” to and through the transparent cover 106 where it is perceived by a user of the personal electronics device 100. The result is that the image seen by the user looking at the transparent cover 106 is of the same size as the array of pixels 200 of the display screen 104.

In comparison with FIG. 2a, FIG. 2b shows a result achieved by embodiments of the present invention. In FIG. 2b, the image produced by the light emitted from the pixels 200 of the display screen 104 is magnified when viewed through the transparent cover 106. This is accomplished by angularly shifting the light emitted by each pixel 200 in the display screen 104 before the light reaches the transparent cover 106. Note the regular spacing of the pixel light on the transparent cover 106. This regularity allows the image to be magnified without being distorted. To achieve this regularity, the angles of the light shift from the display screen 104 to the transparent cover 106 are not all the same. For example, light from the middle pixel 200 goes straight “up” as before, while light from pixels 200 farther and farther from the center goes through greater and greater angular shifts.

(As noted above in reference to FIG. 2a, the array of pixels 200 in FIG. 2b is actually two-dimensional. Thus, the angular shift required for each pixel 200 in the array is determined by the pixel's position in both the X- and Y-dimensions of the array. This is simple geometry.)

Several possible ways of achieving the angular shifts of FIG. 2b are contemplated. For example, an optical fiber can be run from each pixel 200 in the display screen 104 to the desired position of that pixel's light on the transparent cover 106. Alternatively, an array of micro-lenses or micro-mirrors (one per pixel 200) can be positioned between the display screen 104 and the transparent cover 106 to shift the light. For each pixel 200, the micro-lens or micro-mirror is configured to provide just the right amount of angular shift for that pixel 200. These approaches have shortcomings, however. In particular, they can only achieve a significant amount of magnification if the separation between the “top” of the display screen 104 and the “bottom” of the transparent cover 106 is also significant. In the interests of clarity, FIGS. 2a, 2b, and the following figures are not drawn to scale. In actuality, to achieve a desired thinness in the personal electronics device 100, this separation is kept very small in comparison with the width of the display screen 104. Therefore, embodiments using the approaches listed in this paragraph usually cannot achieve significant magnification given the constraint of maintaining a small separation between the display screen 104 and the transparent cover 106.

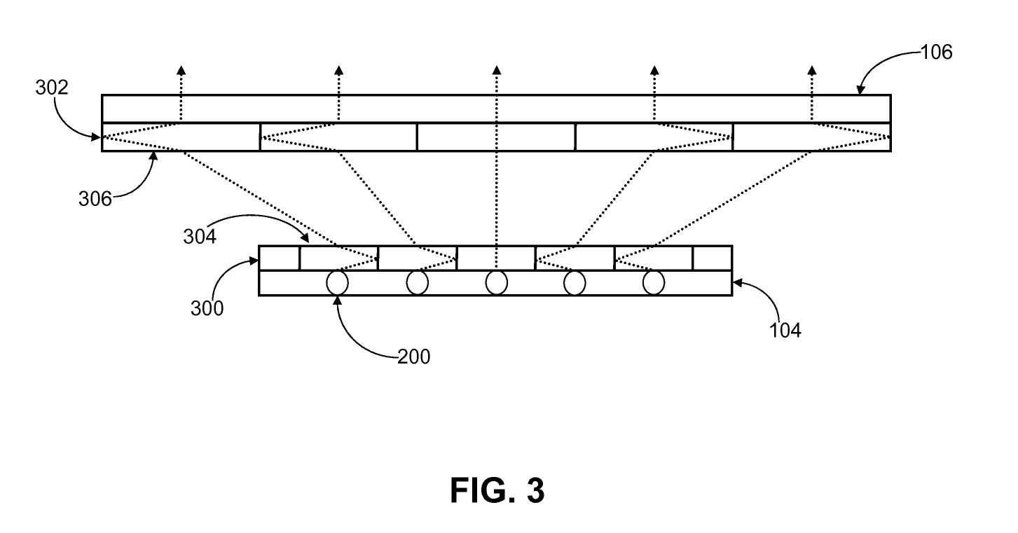

Preferred embodiments of the present invention overcome these limitations and thus achieve a significant magnification without a significant increase in the separation distance. FIGS. 3 through 5 illustrate these preferred embodiments.

In FIG. 3, arrays 300, 302 of optical microelements 304, 306 are disposed between the display screen 104 and the transparent cover 106. Rather than the micro-lenses or micro-mirrors discussed above, the optical microelements 304, 306 comprise diffractive and refractive elements to provide the appropriate angular shift for each pixel 200. The path of the light emitted by the left-most pixel 200 in FIG. 3 shows how this embodiment combines diffraction, total internal reflection, and refraction to move the light from its originating pixel 200 in the display screen 104 to the position on the transparent cover 106 appropriate to create a clear, magnified image.

The arrays 300, 302 of optical microelements 304, 306 can be manufactured by known techniques such as microlithography or micromachining. The arrays 300, 302 can be instantiated as diffractive gratings. While FIG. 3 shows four distinct “layers” (i.e., the display screen 104, the two arrays 300, 302 of optical microelements 304, 306, and the transparent cover 106), in some embodiments the manufacturing can be simplified by combining two or more of these “layers” into a single layer. The separation shown between the arrays 300, 302 can be an air gap in some embodiments and need not exist at all in other embodiments.

As discussed above with reference to micro-lenses and micro-mirrors, the diffractive and refractive microelements 304, 306 are configured for each specific pixel 200 to generate the magnified image. Because each set of microelements 304, 306 is specially configured for one pixel 200, it is an easy matter to create the arrays 300, 302 to accommodate a specific disposition of the transparent cover 106. For example, the arrays 300, 302 can be created for a transparent cover 106 with a curved rather than a flat surface.

The regular spacing of the light positions on the transparent cover 106 is discussed above. In some embodiments, the spacing along one axis of the transparent cover 106 differs from the spacing along the other axis. When this spacing difference is created by the magnification apparatus 300, 302, the magnification is termed “anamorphotic.”

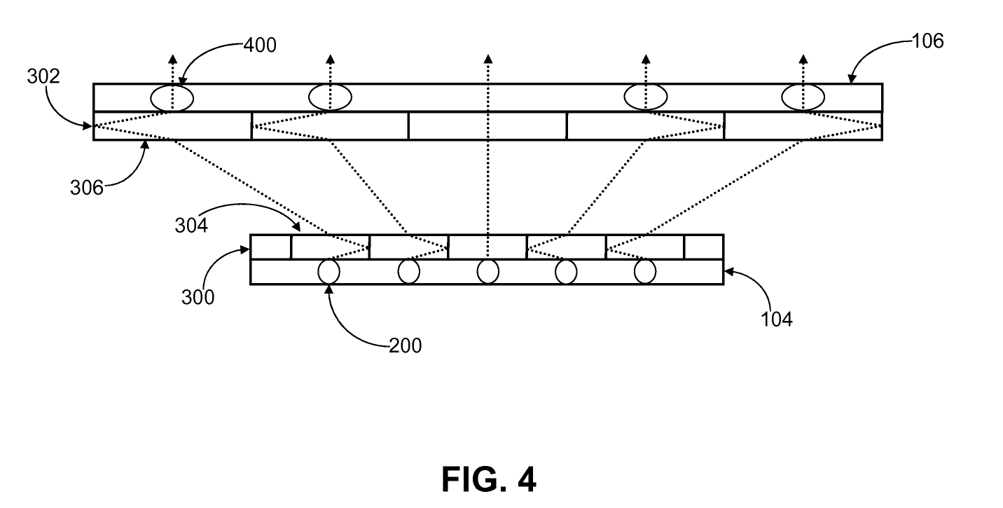

FIG. 4 shows an optional refinement useful in some embodiments of the present invention. As is well known, diffraction and refraction angles depend upon the wavelengths and incident angles of incoming of light. Thus, light emitted by one pixel 200 may end up at slightly different places, or at slightly different angles, on the transparent cover 106. To compensate for this, an array of microlenses 400 is added to collimate the light. These microlenses can be manufactured in a separate layer or combined with other elements into a unified layer and may be formed by known micro-manufacturing techniques.

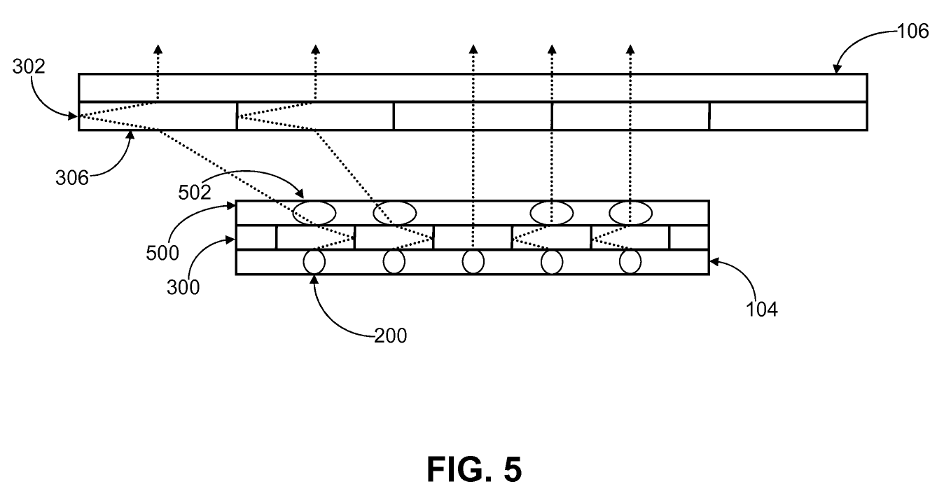

Another option is shown in FIG. 5. An array 500 of liquid matching switches 502 is added. These switches 500 have at least two states, and the states are distinguished from one another by how much they angularly shift the light coming through them. In the illustrative, but probably unrealistic, view of FIG. 5, the two liquid matching switches 502 on the right are set for no magnification (as in FIG. 2a), while the two liquid matching switches 502 on the left are set for a normal level of magnification (as in FIG. 3). Usually, of course, all of the liquid matching switches 502 are set to the same state. Because the liquid matching switches 502 are under the control of the processor 112 of the personal electronics device 100, the device 100 can switch among its states of magnification, typically one state being of no magnification at all, and the other states being of varying amounts of magnification up to the greatest amount of magnification compatible with the configuration of the transparent cover 106.

In some embodiments, the switching between magnification states is under the direct control of a user of the personal electronics device 100. The processor 112 can also choose the magnification state based on, for example, the particular information being displayed on the display element 102. Some user applications or operating system utilities may have preferences for whether or not their information is magnified.

In view of the many possible embodiments to which the principles of the present invention may be applied, it should be recognized that the embodiments described herein with respect to the drawing figures are meant to be illustrative only and should not be taken as limiting the scope of the invention. For example, various elements shown separately may be combined for ease of manufacturing. Therefore, the invention as described herein contemplates all such embodiments as may come within the scope of the following claims and equivalents thereof.

We claim:

1. A display element comprising:
a display screen comprising an output surface and a plurality of pixels, each pixel configured for emitting light through the output surface;
a substantially transparent cover overlying the display screen, the cover comprising a bottom surface facing the output surface of the display screen, the bottom surface of the cover extending beyond the output surface of the display screen; and
disposed between the output surface of the display screen and the bottom surface of the cover, a plurality of optical microelements configured to transfer light emitted from the display-screen pixels to the cover;
wherein the optical microelements comprise diffractive elements and refractive elements.

2. The display element of claim 1 wherein the cover comprises an output surface located opposite the bottom surface of the cover and wherein the output surface of the cover is either curved or flat.

3. The display element of claim 1 wherein the optical microelements are formed by microlithography.

4. The display element of claim 1 wherein the optical microelements comprise a plurality of diffractive gratings.

5. The display element of claim 1 comprising at least one optical microelement for each of a plurality of the display-screen pixels.

6. The display element of claim 1 wherein the plurality of optical microelements are together configured to magnify an image produced by the display-screen pixels onto the cover.

7. The display element of claim 5 wherein the magnification of the image is anamorphotic.

8. The display element of claim 1 further comprising:
an air gap disposed between the display screen and the cover.

9. The display element of claim 1 further comprising:
for each of a plurality of the display-screen pixels, a microlens configured to collimate the light emitted from the display-screen pixel.

10. The display element of claim 1 further comprising:
for each of a plurality of the display-screen pixels, a liquid matching switch;
wherein the display element supports at least two display states;
wherein in a first display state of the display element, the liquid matching switches are configured to transfer an image produced by the display-screen pixels onto the cover at a first magnification level; and
wherein in a second display state of the display element, the liquid matching switches are configured to transfer an image produced by the display-screen pixels onto the cover at a second magnification level.

11. The display element of claim 10 wherein the first magnification level represents no magnification and wherein the second magnification level represents a positive magnification.

12. A personal electronics device comprising:
a memory configured for storing image information;
a display element comprising:
a display screen comprising an output surface and a plurality of pixels, each pixel configured for emitting light through the output surface;
a substantially transparent cover overlying the display screen, the cover comprising a bottom surface facing the output surface of the display screen, the bottom surface of the cover extending beyond the output surface of the display screen; and
disposed between the output surface of the display screen and the bottom surface of the cover, a plurality of optical microelements configured to transfer light emitted from the display-screen pixels to the cover;
wherein the optical microelements comprise diffractive elements and refractive elements; and
a processor operatively coupled to the memory and to the display element and configured for directing image information from the memory for display on the display element.

13. The personal electronics device of claim 12 wherein the device is selected from the group consisting of: a personal digital assistant, a cellular telephone, and a personal computer.

14. The personal electronics device of claim 12 wherein the optical microelements comprise a plurality of diffractive gratings.

15. The personal electronics device of claim 12:
wherein the display element further comprises, for each of a plurality of the display-screen pixels, a liquid matching switch;
wherein the display element supports at least two display states;
wherein in a first display state of the display element, the liquid matching switches are configured to transfer an image produced by the display-screen pixels onto the cover at a first magnification level;
wherein in a second display state of the display element, the liquid matching switches are configured to transfer an image produced by the display-screen pixels onto the cover at a second magnification level; and
wherein the processor is further configured for choosing one of the display states for the display element.

16. The personal electronics device of claim 15 wherein the processor's choice of a display state for the display element is based, at least in part, on an input from an element selected from the group consisting of: a user of the personal electronics device, an application program, a utility program, and an operating system.
